(19) United States
(12) Patent Application Publication
(10) Pub. No.: US 2025/0210057 A1
(43) Pub. Date: Jun. 26, 2025

(54) METHOD, SYSTEM, DEVICE, AND STORAGE MEDIUM FOR SPEECH ENHANCEMENT

(71) Applicant: Beijing Zitiao Network Technology Co., Ltd., Beijing (CN)

(72) Inventors: Xiaohuai LE, Beijing (CN); Xianjun XIA, Sydney (AU); Yijian XIAO, Beijing (CN)

(21) Appl. No.: 18/982,814

(22) Filed: Dec. 16, 2024

(30) Foreign Application Priority Data
Dec. 22, 2023 (CN) 202311792001.X

(51) Int. Cl. G10L 21/0264; G10L 21/0232; G10L 25/06; G10L 25/18; G10L 25/21

(52) U.S. Cl. CPC G10L 21/0264; G10L 21/0232; G10L 25/06; G10L 25/18; G10L 25/21

(57) ABSTRACT

The present disclosure relates to a field of computer technology and discloses a method, a system, a device, and storage medium for speech enhancement. The method for speech enhancement comprises acquiring audio data and, when speech data is detected in the audio data, extracting an embedding vector of the speech data; searching the embedding vector for a target embedding vector extracted from target speech data, and generating a registration embedding vector based on the target embedding vector; performing correlation calculation between the registration embedding vector and an audio feature vector of the audio data, to determine a masking value required for enhancing the target speech data; and enhancing, according to the masking value, the target speech data in the audio data.

### CROSS-REFERENCE TO RELATED APPLICATION(S)

This application claims priority to Chinese Application No. 202311792001.X filed Dec. 22, 2023, the disclosure of which is incorporated herein by reference in its entity.

### FIELD

The present disclosure relates to the field of computer technology, and specifically to a method, system, device, and storage medium for speech enhancement.

### BACKGROUND

In some cases, when a speech sensor is used to collect a speech of a designated speaker, various interference sounds, such as background noise, room reverberation, and speech of other speakers, are usually collected. These interference sounds may affect the audio quality, making it difficult to hear the speech of the designated speaker. In this context, speech enhancement technology has emerged. The so-called speech enhancement is to enhance the speech of the designated speaker in the collected audio and eliminate or weaken other interference sounds (such as background noise and language signals of other speakers). In this way, the audio quality is improved.

Currently, before performing speech enhancement, it is usually necessary for the designated speaker to provide a clear speech in advance for registration, so that the designated speaker's speech can be enhanced based on the pre-registered clear speech. This method for speech enhancement is not suitable for real-time scenarios. The so-called real-time scenario may be a scenario where speech enhancement is still required without performing speech registration in advance. For example, in some occasions where it is necessary to play the audio collected on site in real time, because it is impossible to determine the specific speaker in advance, speech registration cannot be performed in advance, but during real-time playback, in order to improve the audio quality, there is still a need for speech enhancement. This is something that current speech enhancement technology cannot achieve.

Therefore, there is an urgent need for a method that can achieve audio enhancement in real-time scenarios.

### SUMMARY

In view of the above, implementations of the present disclosure provide a method for speech enhancement, a system for speech enhancement, an electronic device and a computer-readable storage medium, supporting audio enhancement in real-time scenarios.

The present disclosure, on one hand, provides a method for speech enhancement. The method comprises: acquiring audio data and, in response to speech data being detected in the audio data, extracting an embedding vector of the speech data; searching the embedding vector for a target embedding vector extracted from target speech data, and generating a registration embedding vector based on the target embedding vector; performing a correlation calculation between the registration embedding vector and an audio feature vector of the audio data, to determine a masking value required for enhancing the target speech data; and enhancing, according to the masking value, the target speech data in the audio data.

On another hand, the present disclosure further provides a system for speech enhancement. The system comprises: an audio acquisition module configured to acquire audio data and, in response to speech data being detected in the audio data, extract an embedding vector of the speech data; a vector searching module configured to search the embedding vector for a target embedding vector extracted from target speech data, and generate a registration embedding vector based on the target embedding vector; an enhancement calculation module configured to perform a correlation calculation between the registration embedding vector and an audio feature vector of the audio data to determine a masking value required for enhancing the target speech data; and an enhancement module configured to enhance, according to the masking value, the target speech data in the audio data.

Additionally, the present disclosure provides a computer-readable storage medium, wherein the computer-readable storage medium is configured to store a computer program, and when executed by a processor, the computer program implements the method mentioned above.

Furthermore, the present disclosure provides an electronic device, wherein the electronic device comprises a processor and a memory, the memory is configured to store a computer program, and when executed by the processor, the computer program implements the method mentioned above.

In the technical solutions of some embodiments of the present application, based on the embedding vector extracted from the speech data of the audio data, the target embedding vector extracted from the target speech data can be searched, and the registration embedding vector can be further obtained based on the current embedding vector, and then the masking value required for enhancing the target speech data can be obtained by calculating the correlation between the registration embedding vector and the audio feature vector. In this way, the registration embedding vector can be generated during the acquisition of audio data, and speech enhancement can be achieved based on the registration embedding vector, without the need for pre-registration of audio, thereby achieving the purpose of audio enhancement in real-time scenarios.

### BRIEF DESCRIPTION OF THE DRAWINGS

The features and advantages of the present disclosure will be more clearly understood by referring to the accompanying drawings. The accompanying drawings are schematic and should not be construed as limiting the present disclosure in any way. In the accompanying drawings:

FIG. 1 illustrates a schematic diagram of a method for speech enhancement provided by an embodiment of the present application;

FIG. 2 illustrates a structural diagram of a vector extraction model provided by an embodiment of the present application;

FIG. 3 illustrates a structural diagram of an enhancement model provided by an embodiment of the present application;

FIG. 4 illustrates a schematic diagram of a speech registration process provided by an embodiment of the present application;

FIG. 5 illustrates a modular diagram of a system for speech enhancement provided by an embodiment of the present application;

FIG. 6 illustrates a schematic diagram of an electronic device provided by an embodiment of the present application.

### DETAILED DESCRIPTION OF EMBODIMENTS

To make the objectives, technical solutions, and advantages of the implementations of the present disclosure clearer, the technical solutions of the implementations of the present disclosure will be described clearly and comprehensively below in conjunction with the accompanying drawings of the implementations of the present disclosure. It is evident that the described implementations are part of the implementations of the present disclosure, but not all of the implementations. Based on the implementations disclosed in the present application, all other implementations obtained by those skilled in the art without requiring inventive effort are within the protection scope of the present disclosure.

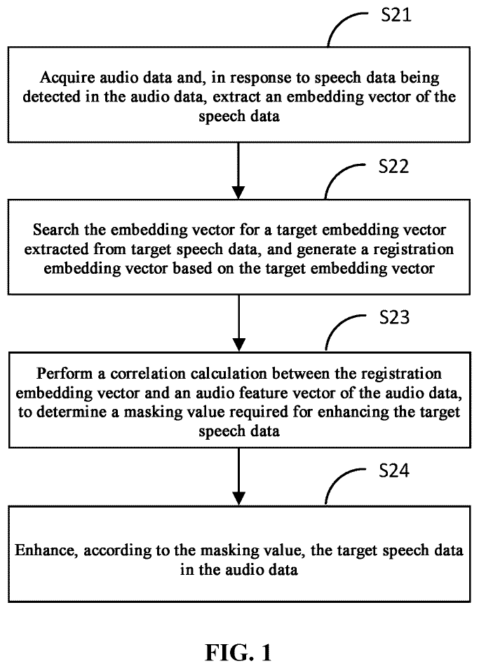

The present application provides a method for speech enhancement, which supports audio enhancement in real-time scenarios. The method for speech enhancement may be applied to electronic devices. The electronic devices include, but are not limited to, tablets, desktop computers, laptops, servers, and the like. FIG. 1 illustrates a schematic diagram of a method for speech enhancement provided by an embodiment of the present application. In FIG. 1, the method for speech enhancement comprises the following steps:

At step S11, audio data is acquired and, when speech data is detected in the audio data, an embedding vector of the speech data is extracted.

In this embodiment, acquiring audio data may refer to audio collection through an audio collection device (such as a sensor). For example, recording the situation at a conference site through an audio collection device.

In some other embodiments, acquiring audio data may refer to acquiring audio data that has been collected from other devices. For example, the complete recording data for the situation at the conference site is stored in device A, and device B acquires the complete recording data from device A.

The acquired audio data may comprise speech data and non-speech data. Therein, speech data may refer to the speech of one or more speakers collected by the audio collection device, and non-speech data may refer to the sound generated by other sound sources other than the speaker and collected by the audio collection device, such as environmental noise, room reverberation, water flow, car sound, etc.

In the process of acquiring audio data, voice activity detection (VAD) may be performed on the acquired audio data at the same time. If speech data is detected in the audio data, the embedding vector of the speech data may be extracted. Therein, the embedding vector refers to the speech features extracted from the speech data, such as timbre, pitch, volume, speech generation time, etc. The following describes the extraction of embedding vectors for speech data.

In this embodiment, after the speech data is detected, the embedding vectors may be extracted for the speech data in a plurality of different time periods, so as to obtain a plurality of embedding vectors. Specifically, starting from the time point when the speech data is detected, the preset time length may be used as a time period, and the embedding vectors may be extracted for the speech data in each time period. For example, assuming that the time point of detecting the speech data is 10:30:01, and the preset duration is 0.5 seconds, then the time period from 10:30:01 to 10:30:01.5 may be used as the first time period, and the embedding vector 1 may be extracted from the speech data in this time period; and the time period from 10:30:01.5 to 10:30:02 may be used as the second time period, and the embedding vector 2 may be extracted from the speech data in this time period; and so on.

Further, it can be understood that in audio data, speech data may be a plurality of non-continuous segments of data. For example, between 10:00 and 10:03, the speech data A1 of speaker A may be collected; between 10:05 and 10:06, the speech data B1 of speaker B may be collected; between 10:08 and 10:10, the speech data A2 of speaker A may be collected. In view of this, speech activity detection may be continuously performed in the process of acquiring audio data. If speech data is detected, the preset duration (such as 0.5 seconds) is used as a time period starting from the time when the speech data is detected, and the embedding vectors are extracted for the audio data in each time period. If no speech data is detected, the extraction of embedding vectors is stopped. In this way, a plurality of embedding vectors may be extracted for each segment of speech data. For example, assuming that the preset duration is 0.5 seconds, then between 10:00 and 10:03 as mentioned above, 360 embedding vectors may be extracted from the speech data A1 of speaker A; between 10:05 and 10:06 as mentioned above, 60 embedding vectors may be extracted from the speech data B1 of speaker B; between 10:08 and 10:10 as mentioned above, 240 embedding vectors may be extracted from the speech data A2 of speaker A. From the above example, it can be understood that a plurality of embedding vectors may be extracted from the speech data of the same speaker.

At this point, the relevant description of embedding vector extraction is completed.

After extracting and obtaining the embedding vector, steps S12 and S13 may be performed. It should be noted that in the process of performing steps S12 and S13, step S11 may be continued at the same time. In other words, after a portion of the embedding vectors are extracted at step S11, steps S12 and S13 may be performed based on the embedding vectors that have been extracted, and step S11 may be continued in order to perform subsequent audio data collection and embedding vector extraction. Based on the embedding vectors that are subsequently extracted, steps S12 and S13 may be performed again.

At step S12, the embedding vector is searched for a target embedding vector extracted from target speech data, and a registration embedding vector is generated based on the target embedding vector.

Therein, the target speech data may be speech data corresponding to the target speaker in the audio data. Therein, the target speaker may be a speaker in the audio data that meets the preset conditions and needs to be speech enhanced. For example, the target speaker may be the speaker who speaks at the very beginning in the audio data. For another example, the target speaker may be a speaker whose speaking volume exceeds a volume threshold in the audio data.

After determining the target speech data, the target embedding vector extracted from the target speech data may be searched in the embedding vectors extracted at step S11. Specifically, it can be understood that the embedding vectors extracted from the speech data of the same speaker should have similarity. For example, timbre, pitch and the like should have similarity. In view of this, the embedding vectors that meet the similarity conditions may be clustered among the plurality of embedding vectors obtained at step S11, to obtain one or more embedding vector clusters. The one or more embedding vector clusters obtained here may be one or more embedding vector clusters divided by speaker. Furthermore, the embedding vector in the embedding vector cluster corresponding to the target speaker may be used as the target embedding vector. For example, assuming that there are three speakers A, B, and C in the audio data, and speaker A is the target speaker. After clustering the embedding vectors according to similarity, the plurality of embedding vectors extracted at step S11 may be divided into three embedding vector clusters a, b, and c. In the embedding vector clusters a, b, and c, the embedding vector cluster divided for speaker A may be found, and then the embedding vector in the corresponding embedding vector cluster may be used as the target embedding vector.

Further, when searching for the embedding vector cluster divided for the target speaker, the search may be based on the preset conditions that the target speaker must meet. For example, when the target speaker is the speaker who speaks at the very beginning in the audio data, the first embedding vector must be extracted from the speech data of the target speaker. Therefore, the embedding vector cluster where the first embedding vector is located may be found, and then the embedding vector in the corresponding embedding vector cluster may be used as the target embedding vector.

By searching the target embedding vector extracted from the target speech data in the form of an embedding vector cluster, the search accuracy can be ensured and the problem of missing searches can be avoided.

Further, when generating the registration embedding vector based on the target embedding vector, the target embedding vector may be averaged and the vector obtained by the average calculation may be used as the registration embedding vector. The registration embedding vector obtained by the average calculation may more accurately reflect the speech data features of the target speaker, thereby improving the accuracy of data enhancement in the future.

At step S13, a correlation calculation is performed between the registration embedding vector and an audio feature vector of the audio data, to determine a masking value required for enhancing the target speech data.

Specifically, for features with a relatively high correlation between the audio feature vector and the registration embedding vector, it means that these features are features that are more related to the target speech data, and these features may be enhanced in the audio feature vector (that is, these features may have a larger weight); and for features with a relatively low correlation between the audio feature vector and the registration embedding vector, it means that these features are features that are less related to the target speech data, and these features may be weakened or eliminated in the audio feature vector (that is, these features may have a smaller weight). According to the above principle, the masking value may be obtained.

At step S14, according to the masking value, the target speech data in the audio data is enhanced.

Specifically, the masking value may be multiplied by a first complex spectrum of the audio data to obtain a second complex spectrum of the enhanced audio data, and finally the enhanced speech data is obtained by inverse short-time Fourier transform.

In summary, in the technical solutions of some embodiments of the present application, based on the embedding vector extracted from the speech data of the audio data, the target embedding vector extracted from the target speech data may be searched, and the registration embedding vector may be further obtained based on the current embedding vector, and then the masking value required for enhancing the target speech data may be obtained by the correlation calculation between the registration embedding vector and the audio feature vector. In this way, the registration embedding vector may be generated in the process of acquiring the audio data, and speech enhancement may be achieved based on the registration embedding vector, without the need for pre-registration of audio, so as to achieve the purpose of audio enhancement in real-time scenarios.

The solution of the present application is further described below.

In some embodiments, the target speaker may be a speaker located close to the audio collection device. After the speech of the speakers at these locations is collected, the speech data obtained usually has a larger audio energy and signal-to-noise ratio. In view of this, the target embedding vector may be determined based on the audio energy and signal-to-noise ratio of the speech data. Therein, audio energy may also be called as frame level energy, and signal-to-noise ratio may also be called as frame level signal-to-noise ratio (frame level SNR).

Specifically, first, when extracting the embedding vector of the speech data at step S11, the audio energy and signal-to-noise ratio may also be extracted for the speech data in each time period. In this way, the speech data in each time period may actually have three attributes, namely: embedding vector, audio energy and signal-to-noise ratio.

Furthermore, after clustering the embedding vectors at step S12, if the audio energy of the speech data corresponding to an embedding vector cluster among the obtained embedding vector clusters is greater than the energy threshold and/or the signal-to-noise ratio of the speech data is greater than the signal-to-noise ratio threshold, the embedding vector in the embedding vector cluster is used as the target embedding vector. Here, when determining the audio energy and signal-to-noise ratio of the speech data corresponding to an embedding vector cluster, the audio energy of all the speech data corresponding to the embedding vector cluster may be averaged to obtain the audio energy of the speech data corresponding to the embedding vector cluster, and the signal-to-noise ratio of all the speech data corresponding to the embedding vector cluster may be averaged to obtain the signal-to-noise ratio of the speech data corresponding to the embedding vector cluster.

The target embedding vector is searched based on the audio energy and signal-to-noise ratio of the speech data, and thus the obtained target embedding vector is more accurate.

In some embodiments, if there are many speakers in a segment of audio data, it may be indicated that the speech data of these speakers have the same importance, and there is no need to enhance the speech data of one of the speakers. In view of this, whether to search for the target embedding vector may be determined based on the number of embedding vector clusters (i.e., the number of speakers). Specifically, a search for the target embedding vector may be triggered in a case that the number of the embedding vector clusters is less than a cluster threshold, and the search for the target embedding vector is not triggered in a case that the number of the embedding vector clusters is greater than or equal to the cluster threshold, thereby preventing the speech data of some speakers from being weakened or eliminated by mistake.

The method for determining the masking value is further described in detail below.

In some embodiments, the audio feature vector may comprise a plurality of sub-audio feature vectors divided by frequency bands and extracted from a complex spectrum of the audio data. The step S13 of determining the masking value required for enhancing the target speech data may comprise: 1) performing a correlation calculation between the registration embedding vector and each of the sub-audio feature vectors respectively, to obtain a correlation degree between the registration embedding vector and each of the sub-audio feature vectors; 2) performing feature scaling on a feature in the audio feature vector according to the correlation degree; and 3) determining the masking value used for enhancing the target speech data based on the audio feature vector after the feature scaling.

Specifically, if a sub-audio feature vector has a large correlation with the registration embedding vector, it can be indicated that the sub-audio feature vector can more accurately represent the features of the target speech data. Therefore, when feature scaling is performed on the audio feature vector, the sub-audio feature vector may have a higher weight. If a sub-audio feature vector has a low correlation with the registration embedding vector, it can be indicated that the features represented by the sub-audio feature vector are not highly correlated with the features of the target speech data. Therefore, when feature scaling is performed on the audio feature vector, the sub-audio feature vector may have a lower weight. In this way, among the audio feature vectors that have completed feature scaling, the sub-audio feature vectors that have a large correlation with the features of the target speech data may have a higher weight, while the sub-audio feature vectors that have little correlation with the target speech data may have a lower weight. That is, the audio feature vector after feature scaling can more accurately reflect the features of the target speech data. In this way, based on the audio feature vector after feature scaling, the masking value used when enhancing the target speech data can be determined.

The audio feature vector is divided into a plurality of sub-audio feature vectors, so that the features with greater correlation with the features of the target speech data can be extracted from the audio feature vector, so that the audio feature vector after feature scaling can accurately represent the features of the target speech data.

Further, in some embodiments, the feature dimension of the registration embedding vector may be different from the feature dimension of each sub-audio feature vector, resulting in the inability to perform correlation calculation between the registration embedding vector and the sub-audio feature vector. In view of this, prior to performing a correlation calculation between the registration embedding vector and each of the sub-audio feature vectors respectively, the method of the present application may also comprise: in a case that a feature dimension of the registration embedding vector is inconsistent with that of the sub-audio feature vector, mapping the registration embedding vector and each of the sub-audio feature vectors to the same feature dimension.

In this way, the correlation calculation between the registration embedding vector and the sub-audio feature vector is performed.

The solution of the present application is further described below in conjunction with a specific embodiment.

This embodiment mainly comprises two stages, the first stage is for model construction and training, and the second stage is to execute the method for speech enhancement of the present application based on the trained model. The two stages are described below.

### The First Stage

In this embodiment, two models may be pre-built and trained, one of which is a vector extraction model for extracting the embedding vector, and the other is an enhancement model for calculating the masking value. The first stage may comprise steps 1) to 3):
1) Constructing a Training data set

Specifically, the training data set may comprise sample speech data, sample non-speech data, and other speech data other than sample speech data for model training. The sample speech data is defined as sᵢ(t), the sample non-speech data is defined as nᵢ(t), and other speech data other than the sample speech data sᵢ(t) is defined as sₙᵢ(t). The constructed training data set xᵢ(t) may be shown as Expression (1):

$${x}_{i} ( t ) = {s}_{i} ( t ) + {n}_{i} ( t ) + {s}_{ni} ( t ) \qquad ( 1 )$$

The audio data in the constructed training data set xᵢ(t) may be referred to as sample audio data. A short-time Fourier transform of Nf point may be performed on xᵢ(t) to obtain a complex spectrum xᵢϵC^{(T×F)} of T frames and F dimensions, where F=Nf/2+1 and i is an integer greater than 0.
2) Constructing and training a vector extraction model, which may specifically comprise steps 21) and 22).
21) Constructing a vector extraction model.

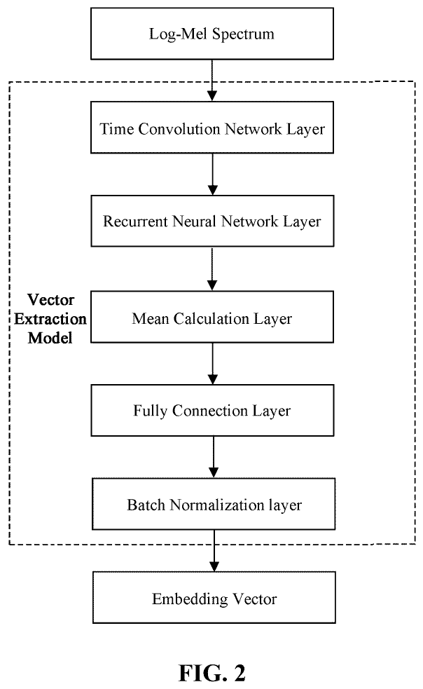

FIG. 2 illustrates a structural diagram of a vector extraction model provided by an embodiment of the present application.

In this embodiment, considering that the vector extraction model needs to run in real time, in order to reduce latency, a vector extraction model may be constructed by cascading a temporal convolutional network layer (TCN) and a recurrent neural network (RNN). At the same time, the vector extraction model may also comprise a mean calculation layer, a fully connection layer, and a batch normalization layer. The working principle of the vector extraction model is that after the Log-Mel spectrum of the sample audio data is input into the trained vector extraction model, the sample speech data information (such as pitch, timbre, etc.) at each moment in the sample audio data may be extracted through the time convolution network layer and the recurrent neural network. After the sample speech data information at each moment is averaged through the mean calculation layer, more accurate sample speech data information may be obtained. Furthermore, through a fully connection layer and a batch normalization layer (such as L2 norm normalization), the embedding vector of the sample speech data may be extracted and obtained from the sample speech data information after the average calculation.
22) Training vector extraction model.

Specifically, when training the vector extraction model, a sample speech data sᵢ(t) may be randomly selected from the training data set, and the embedding vector of the sample speech data sᵢ(t) may be determined. Then, the sample audio data xᵢ(t)=sᵢ(t)+nᵢ(t)+sₙᵢ(t) is input into the vector extraction model, and the sample audio data xᵢ(t) is annotated using the embedding vector of the sample speech data sᵢ(t), to train the vector extraction model. Therein, in the training process, the AAMsoftmax loss function may be used to calculate the error to adjust the parameters of the vector extraction model.
3) Constructing and training the enhancement model, which may specifically comprise steps 31) and 32).
31) Constructing an enhancement model

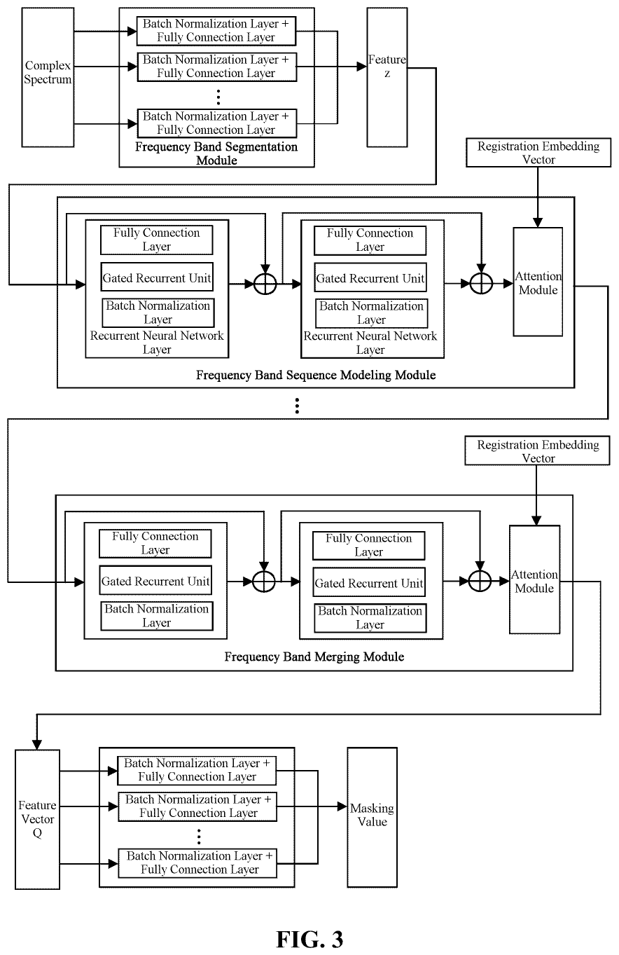

FIG. 3 illustrates a structural diagram of an enhancement model provided by an embodiment of the present application. In FIG. 3, the enhancement model comprises a frequency band segmentation module, a frequency band merging module, and a plurality of cascaded frequency band sequence modeling modules, wherein: the frequency band segmentation module comprises K independent batch normalization (BN) layers+fully connection (FC) layers.

In the plurality of cascaded frequency band sequence modeling modules, each frequency band sequence modeling module comprises two cascaded recurrent neural network (RNN) layers and an attention module. Therein, in the two cascaded recurrent neural network layers, each recurrent neural network layer comprises a fully connection (FC) layer, a gated recurrent unit (GRU) and a batch normalization layer (Layer Normalization).

The frequency band merging module comprises K independent batch normalization (BN) layers+fully connection (FC) layers. The frequency band merging module is symmetrical with the frequency band segmentation module.

Based on the above structural introduction of the enhancement model, the training process of the enhancement model includes the following actions.

For the complex spectrum xᵢϵC^{T×F} of the sample audio data, the real part and the imaginary part of the complex spectrum xᵢ may be concatenated into a 2F-dimensional real vector, and then the concatenated real vector is input into the frequency band segmentation module, and the frequency band segmentation module divides the complex spectrum xᵢ into K sub-bands. Each sub-band may be defined as BₖϵR^{T×G}^{_{R}}. The sub-bands correspond to the batch normalization layer+fully connection layer in the band segmentation module one by one. After each sub-band passes through the corresponding batch normalization layer+fully connection layer, a concatenated sample audio feature vector zϵR^{C×T×K} may be obtained, where C represents the channel dimension of the feature (i.e., the feature dimension). The sample audio feature vector z may comprise a plurality of sub-sample audio feature vectors divided by frequency bands. Furthermore, the sample audio feature vector z may be input into the first frequency band sequence modeling module. In the first frequency band sequence modeling module, one recurrent neural network may process the dependency of the sample audio feature vector z between frequency bands, and the other recurrent neural network may process the dependency of the sample audio feature vector z in time. After being processed by the two recurrent neural networks, the sample audio feature vector z may be changed to a sample audio feature vector hϵR^{C×T×K}.

The attention module may be used to introduce the sample registration embedding vector e, and perform correlation calculations on the sample registration embedding vector e and each sub-sample audio feature vector of the sample audio feature vector h. Specifically, the attention module may map the sample registration embedding vector e and the sample audio feature vector h to the same feature dimension through two fully connection layers (not shown in FIG. 3). This process can be represented by Expression (2) and Expression (3).

$$k = {FC}_{1} ( e ) ∈ {R}^{{C}_{1}} \qquad ( 2 )$$

$$q = {FC}_{2} ( h ) ∈ {R}^{{C}_{1} \times T \times K} \qquad ( 3 )$$

where k is the output result of one of the fully connection layers of the attention module, and q is the output result of another fully connection layer of the attention module. Expression (2) represents mapping the sample registration embedding vector e to the feature dimension C₁, and Expression (3) represents mapping the sample audio feature vector h to the feature dimension C₁.

Based on Expression (4), the inner product of k and q may be calculated in their channel dimension to obtain the attention weight s (i.e. the above correlation) obtained from the sample registration embedding vector e in each dimension of the sample audio feature vector h:

$$s = Soft max ( \frac{{\sum }_{C} q [ c , : , : ] k [ c ]}{\sqrt{{C}_{1} F / 2}} ) \qquad ( 4 )$$

where \sqrt{C₁F/2} is used to scale the inner product calculation result, and Softmax(⋅) is used to normalize the attention weight s in the frequency band dimension, which is defined as Expression (5):

$$Soft max ( x ) = \frac{exp ( x )}{{\sum }_{k} exp ( x [ : , k ] )} ∈ {R}^{T \times K} \qquad ( 5 )$$

The attention weight s will be used to scale and regularize the time and frequency band dimensions of the sample audio feature vector h. Specifically, the attention weight s and the sample audio feature vector h are multiplied in bitwise order and then processed by a convolution layer, and finally added to the sample audio feature vector h to obtain the final output, as shown in Expression (6).

$$out = {Conv}_{1} ( s ⊙ h ) + h \qquad ( 6 )$$

32) Training the enhancement model

In this embodiment, the enhancement model is trained based on the following method: inputting the complex spectrum of sample audio data and a sample registration embedding vector of the sample speech data into the enhancement model, determining a sample masking value required for enhancing the sample speech data in the sample audio data; and after enhancing the sample speech data in the sample audio data using the sample masking value, calculating magnitude of the error between the enhanced sample audio data and the sample speech data, and adjusting parameters of the enhancement model based on the magnitude of the error.

In the above training method, the parameters of the enhancement model are adjusted based on the magnitude of the error between the enhanced sample audio data and the sample speech data. In this way, after the enhancement model is trained, and the masking value output by the enhancement model in the actual application is used to enhance the audio data, the enhanced audio data may be closer to the clear speech data of the target speaker, and the model accuracy is higher.

In this embodiment, in the training process of the enhancement model, the weighted mean square error (MSE) can be used as the loss function of the model training. The definition of the loss function can be shown as Expression (7):

$$L = λ \times {MSE}_{a} ( \vert {S}_{c} \vert , \vert \hat{{S}_{c}} \vert ) + ( 1 - λ ) \times {MSE}_{c} ( {S}_{c} , \hat{{S}_{c}} ) \qquad ( 7 )$$

where MSEₐ(⋅) and MSE_{c}(⋅) represent the asymmetric mean square error and the compressed spectrum mean square error, respectively. The definition of MSEₐ(⋅) may be shown as Expression (8).

$${MSE}_{a} ( \vert {S}_{c} \vert , \vert \hat{{S}_{c}} \vert ) = \frac{1}{TF} {\sum }_{f} {\sum }_{t} {ReLU ( \vert {S}_{c} [ t , f ] \vert - \vert \hat{{S}_{c}} [ t , f ] \vert )}^{2} \qquad ( 8 )$$

MSE_{c}(⋅) may be defined as shown in Expression (9).

$${MSE}_{c} ( \vert {S}_{c} \vert , \vert \hat{{S}_{c}} \vert ) = \frac{1}{TF} [ λ {\sum }_{t} {\sum }_{f} {( {S}_{c} [ t , f ] \vert - \vert \hat{{S}_{c}} [ t , f ] )}^{2} + ( 1 - λ ) {\sum }_{t} {\sum }_{f} {( {S}_{c} [ t , f ] \vert - \vert \hat{{S}_{c}} [ t , f ] )}^{2} ] \qquad ( 9 )$$

Furthermore, ReLU(⋅) can be shown as Expression (10).

$$ReLU ( x ) = \{ \begin{matrix}0 if x \leq 0 \\ x if x > 0\end{matrix} \qquad ( 10 )$$

where λ=0.3 is the weighting coefficient, S and Ŝ represent the complex spectra of clear speech data and enhanced audio data respectively, S_{c} and [symbol] represent the corresponding amplitude compression spectra respectively, which can be calculated by Expressions (11) and (12).

$${S}_{c} = \frac{S}{\vert S \vert} {\vert S \vert}^{c} \qquad ( 11 )$$

$$\hat{{S}_{c}} = \frac{\hat{S}}{\vert \hat{S} \vert} {\vert \hat{S} \vert}^{c} \qquad ( 12 )$$

where c represents the amplitude compression power value, which can be 0.3.

At this point, the relevant description of the first stage is completed.

### The Second Stage

In this stage, specifically, the method for speech enhancement of the present application is executed based on the trained model and the audio data acquired in the actual application scenario. Specifically, this stage can be mainly divided into three steps: speech registration, masking value determination and speech enhancement, which are respectively described in steps 41) to 43) below.
41) Speech registration

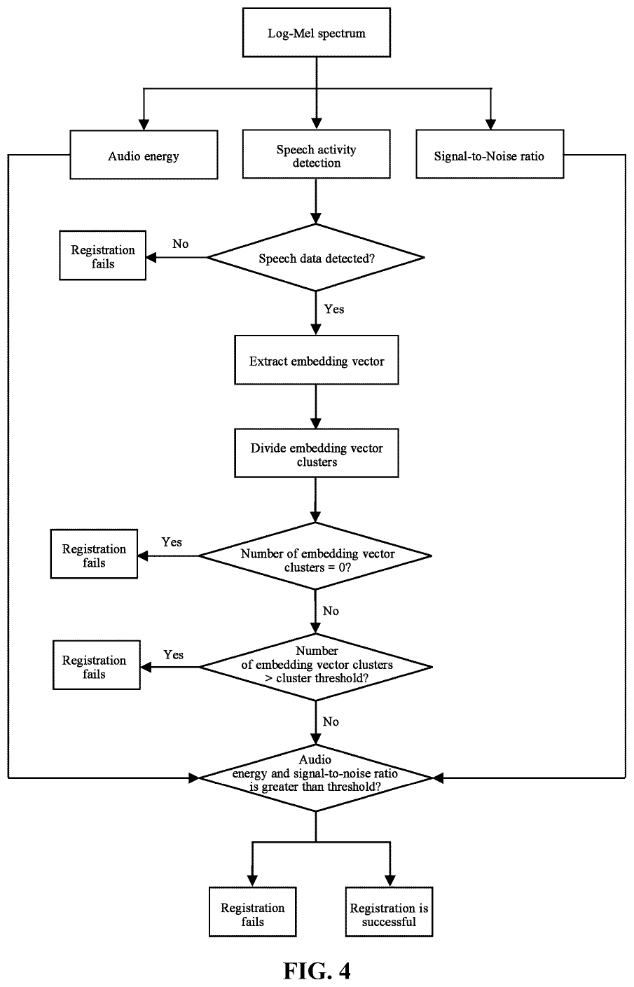

FIG. 4 illustrates a schematic diagram of a speech registration process provided by an embodiment of the present application. Therein, speech registration is to generate a registration embedding vector. The process shown in FIG. 4 may specifically comprise the following steps 411) to 415:
411) In the process of acquiring audio data, it can be detected based on the speech activity detection technology whether there is speech data in the Log-Mel spectrum of the audio data. If no speech data is detected, it means that the speech registration fails; if speech data is detected, 412) is executed.
412) Starting from the moment when speech data is detected, the embedding vector of speech data is extracted in a plurality of different time periods, and at the same time, the audio energy and signal-to-noise ratio of speech data in each time period are extracted.

The following takes one time period A as an example. The Log-Mel spectrum of audio data (i.e., including speech data and non-speech data) in time period A may be input into the trained vector extraction model, and the vector extraction model extracts and obtains the embedding vector of speech data in time period A from the Log-Mel spectrum of audio data. At the same time, the audio energy and signal-to-noise ratio of speech data in time period A are extracted. The speech data in time period A may have three attributes, namely, embedding vector, audio energy and signal-to-noise ratio.
413) After acquiring a plurality of embedding vectors at different time periods, the embedding vectors among the plurality of embedding vectors that meet the similarity conditions may be clustered to obtain one or more embedding vector clusters. This step is the division of embedding vector clusters in FIG. 4.
414) It is determined whether the number of embedding vector clusters is 0 or greater than the cluster threshold. If so, it is determined that the registration has failed. If not, step 45) is executed.
415) Based on the audio energy and signal-to-noise ratio of the audio data corresponding to each embedding vector cluster, it is searched whether there is an embedding vector cluster whose audio energy is greater than the energy threshold and whose signal-to-noise ratio is greater than the signal-to-noise ratio threshold. If so, the embedding vectors in the embedding vector cluster are averaged to obtain the registration embedding vector, and the registration is successful. If not, it is determined that the registration has failed.
42) Determination of the masking value

In this step, the masking value determined at step 41) and the complex spectrum of the audio data are input into the trained enhancement model to obtain the masking value.
43) Speech enhancement

The masking value is multiplied by the first complex spectrum of the audio data to obtain the second complex spectrum of the enhanced audio data, and finally the enhanced speech data is obtained by inverse short-time Fourier transform.

At this point, the relevant description of the method for speech enhancement of the present application is completed.

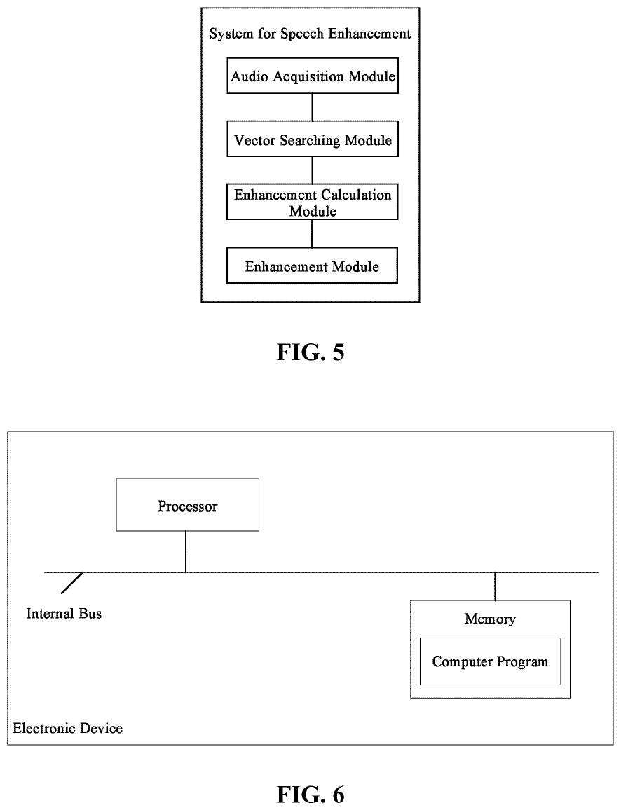

Corresponding to the method for speech enhancement, the present application also provides a system for speech enhancement. FIG. 5 illustrates a modular diagram of a system for speech enhancement provided by an embodiment of the present application. In FIG. 5, the system for speech enhancement comprises: an audio acquisition module configured to acquire audio data and, when speech data is detected in the audio data, extract an embedding vector of the speech data; a vector searching module configured to search the embedding vector for a target embedding vector extracted from target speech data, and generate a registration embedding vector based on the target embedding vector; an enhancement calculation module configured to perform a correlation calculation between the registration embedding vector and an audio feature vector of the audio data to determine a masking value required for enhancing the target speech data; and an enhancement module configured to enhance, according to the masking value, the target speech data in the audio data.

FIG. 6 illustrates a schematic diagram of an electronic device provided by an embodiment of the present application. The electronic device comprises a processor and a memory. The memory is configured to store a computer program, and when executed by the processor, the computer program implements the above-mentioned method.

Therein, the processor may be a central processing unit (CPU). The processor may also be other general-purpose processors, digital signal processors (DSP), application specific integrated circuits (ASIC), field programmable gate arrays (FPGA) or other programmable logic devices, discrete gates or transistor logic devices, discrete hardware components and other chips, or a combination of the above chips.

As a non-transient computer-readable storage medium, the memory may be configured to store non-transient software programs, non-transient computer executable programs and modules, such as program instructions/modules corresponding to the method in the implementation of the present invention. The processor executes various functional applications and data processing of the processor by running the non-transient software programs, instructions and modules stored in the memory, i.e., implementing the method in the above-mentioned method implementation.

The memory may comprise a program storage area and a data storage area, wherein the program storage area can store an operating system and an application required by at least one function; the data storage area can store data created by the processor, etc. In addition, the memory may comprise a high-speed random access memory, and may also comprise a non-transient memory, such as at least one disk storage device, a flash memory device, or other non-transient solid-state storage device. In some implementations, the memory may optionally comprise a memory remotely arranged relative to the processor, and these remote memories may be connected to the processor via a network. Examples of the above-mentioned network include, but are not limited to, the Internet, an intranet, a local area network, a mobile communication network, and a combination thereof.

An implementation of the present application also provides a computer-readable storage medium, which is configured to store a computer program, and when executed by the processor, the computer program implements the above-mentioned method.

Although the implementation of the present disclosure is described in conjunction with the accompanying drawings, those skilled in the art may make various modifications and variations without departing from the spirit and scope of the present disclosure, and such modifications and variations are all within the scope defined by the attached claims.

I/We claim:

1. A method for speech enhancement, comprising:
acquiring audio data and, in response to speech data being detected in the audio data, extracting an embedding vector of the speech data;
searching the embedding vector for a target embedding vector extracted from target speech data, and generating a registration embedding vector based on the target embedding vector;
performing a correlation calculation between the registration embedding vector and an audio feature vector of the audio data, to determine a masking value required for enhancing the target speech data; and
enhancing, according to the masking value, the target speech data in the audio data.

2. The method according to claim 1, wherein extracting the embedding vector of the speech data comprises:
extracting embedding vectors for speech data within a plurality of different time periods respectively, to obtain a plurality of embedding vectors; and
wherein searching the embedding vector for the target embedding vector extracted from the target speech data comprises:
clustering the embedding vectors satisfying a similarity condition among the plurality of embedding vectors, to obtain one or more embedding vector clusters; and
using, in response to audio energy of the speech data corresponding to an embedding vector cluster among the obtained embedding vector clusters being greater than an energy threshold and/or a signal-to-noise ratio of the speech data being greater than a signal-to-noise ratio threshold, the embedding vector in the embedding vector cluster as the target embedding vector.

3. The method according to claim 2, wherein generating the registration embedding vector based on the target embedding vector comprises:
averaging the target embedding vectors; and
using a vector obtained by the averaging as the registration embedding vector.

4. The method according to claim 2, wherein searching the embedding vector for the target embedding vector extracted from target speech data comprises:
triggering a search for the target embedding vector in a case that the number of the embedding vector clusters is less than a cluster threshold; and
stopping triggering of the search for the target embedding vector in a case that the number of the embedding vector clusters is greater than or equal to the cluster threshold.

5. The method according to claim 1, wherein the audio feature vector comprises a plurality of sub-audio feature vectors divided by frequency bands and extracted from a complex spectrum of the audio data; and
wherein determining the masking value required for enhancing the target speech data comprises:
performing a correlation calculation between the registration embedding vector and each of the sub-audio feature vectors respectively, to obtain a correlation degree between the registration embedding vector and each of the sub-audio feature vectors;
performing feature scaling on a feature in the audio feature vector according to the correlation degree; and
determining the masking value used for enhancing the target speech data based on the audio feature vector after feature scaling.

6. The method according to claim 5, further comprising prior to performing a correlation calculation between the registration embedding vector and each of the sub-audio feature vectors respectively:
in a case that a feature dimension of the registration embedding vector is inconsistent with that of the sub-audio feature vector, mapping the registration embedding vector and each of the sub-audio feature vectors to a same feature dimension.

7. The method according to claim 5, wherein a calculation process of the masking value is implemented by a trained enhancement model, and the enhancement model is trained by:
inputting the complex spectrum of sample audio data and a sample registration embedding vector of sample speech data into the enhancement model;
determining a sample masking value required for enhancing the sample speech data in the sample audio data; and
after enhancing the sample speech data in the sample audio data using the sample masking value, calculating magnitude of the error between the enhanced sample audio data and the sample speech data, and adjusting parameters of the enhancement model based on the magnitude of the error.

8. An electronic device, comprising:
a processor and a memory, wherein the memory is configured to store a computer program, and the processor is configured to invoke and run the computer program stored in the memory to:
acquire audio data and, in response to speech data being detected in the audio data, extract an embedding vector of the speech data;
search the embedding vector for a target embedding vector extracted from target speech data, and generate a registration embedding vector based on the target embedding vector;
perform a correlation calculation between the registration embedding vector and an audio feature vector of the audio data, to determine a masking value required for enhancing the target speech data; and
enhance, according to the masking value, the target speech data in the audio data.

9. The electronic device according to claim 8, wherein the computer program causing the processor to extract the embedding vector of the speech data further causes the processor to:
extract embedding vectors for speech data within a plurality of different time periods respectively, to obtain a plurality of embedding vectors; and
wherein the computer program causing the processor to search the embedding vector for the target embedding vector extracted from the target speech data further causes the processor to:
cluster the embedding vectors satisfying a similarity condition among the plurality of embedding vectors, to obtain one or more embedding vector clusters; and
use, in response to audio energy of the speech data corresponding to an embedding vector cluster among the obtained embedding vector clusters being greater than an energy threshold and/or a signal-to-noise ratio of the speech data being greater than a signal-to-noise ratio threshold, the embedding vector in the embedding vector cluster as the target embedding vector.

10. The electronic device according to claim 9, wherein the computer program causing the processor to generate the registration embedding vector based on the target embedding vector further causes the processor to:
average the target embedding vectors; and
use a vector obtained by the averaging as the registration embedding vector.

11. The electronic device according to claim 9, wherein the computer program causing the processor to search the embedding vector for the target embedding vector extracted from target speech data further causes the processor to:
trigger a search for the target embedding vector in a case that the number of the embedding vector clusters is less than a cluster threshold; and
stop triggering of the search for the target embedding vector in a case that the number of the embedding vector clusters is greater than or equal to the cluster threshold.

12. The electronic device according to claim 8, wherein the audio feature vector comprises a plurality of sub-audio feature vectors divided by frequency bands and extracted from a complex spectrum of the audio data; and
wherein the computer program causing the processor to determine the masking value required for enhancing the target speech data further causes the processor to:
perform a correlation calculation between the registration embedding vector and each of the sub-audio feature vectors respectively, to obtain a correlation degree between the registration embedding vector and each of the sub-audio feature vectors;
perform feature scaling on a feature in the audio feature vector according to the correlation degree; and
determine the masking value used for enhancing the target speech data based on the audio feature vector after feature scaling.

13. The electronic device according to claim 12, wherein the processor is further configured to, prior to performing a correlation calculation between the registration embedding vector and each of the sub-audio feature vectors respectively:
in a case that a feature dimension of the registration embedding vector is inconsistent with that of the sub-audio feature vector, map the registration embedding vector and each of the sub-audio feature vectors to a same feature dimension.

14. The electronic device according to claim 12, wherein a calculation process of the masking value is implemented by a trained enhancement model, and the enhancement model is trained by causing the processor to:
input the complex spectrum of sample audio data and a sample registration embedding vector of sample speech data into the enhancement model;
determine a sample masking value required for enhancing the sample speech data in the sample audio data; and
after enhancing the sample speech data in the sample audio data using the sample masking value, calculate magnitude of the error between the enhanced sample audio data and the sample speech data, and adjust parameters of the enhancement model based on the magnitude of the error.

15. A non-transitory computer-readable storage medium, wherein the non-transitory computer-readable storage medium is configured to store a computer program, and the computer program, when executed by a processor, causes the processor to:
acquire audio data and, in response to speech data being detected in the audio data, extract an embedding vector of the speech data;
search the embedding vector for a target embedding vector extracted from target speech data, and generate a registration embedding vector based on the target embedding vector;
perform a correlation calculation between the registration embedding vector and an audio feature vector of the audio data, to determine a masking value required for enhancing the target speech data; and
enhance, according to the masking value, the target speech data in the audio data.

16. The non-transitory computer-readable storage medium according to claim 15, wherein the computer program causing the processor to extract the embedding vector of the speech data further causes the processor to:
extract embedding vectors for speech data within a plurality of different time periods respectively, to obtain a plurality of embedding vectors; and
wherein the computer program causing the processor to search the embedding vector for the target embedding vector extracted from the target speech data further causes the processor to:
cluster the embedding vectors satisfying a similarity condition among the plurality of embedding vectors, to obtain one or more embedding vector clusters; and
use, in response to audio energy of the speech data corresponding to an embedding vector cluster among the obtained embedding vector clusters being greater than an energy threshold and/or a signal-to-noise ratio of the speech data being greater than a signal-to-noise ratio threshold, the embedding vector in the embedding vector cluster as the target embedding vector.

17. The non-transitory computer-readable storage medium according to claim 16, wherein the computer program causing the processor to generate the registration embedding vector based on the target embedding vector further causes the processor to:
average the target embedding vectors; and
use a vector obtained by the averaging as the registration embedding vector.

18. The non-transitory computer-readable storage medium according to claim 16, wherein the computer program causing the processor to search the embedding vector for the target embedding vector extracted from target speech data further causes the processor to:
trigger a search for the target embedding vector in a case that the number of the embedding vector clusters is less than a cluster threshold; and
stop triggering of the search for the target embedding vector in a case that the number of the embedding vector clusters is greater than or equal to the cluster threshold.

19. The non-transitory computer-readable storage medium according to claim 15, wherein the audio feature vector comprises a plurality of sub-audio feature vectors divided by frequency bands and extracted from a complex spectrum of the audio data; and
wherein the computer program causing the processor to determine the masking value required for enhancing the target speech data further causes the processor to:
perform a correlation calculation between the registration embedding vector and each of the sub-audio feature vectors respectively, to obtain a correlation degree between the registration embedding vector and each of the sub-audio feature vectors;
perform feature scaling on a feature in the audio feature vector according to the correlation degree; and
determine the masking value used for enhancing the target speech data based on the audio feature vector after feature scaling.

20. The non-transitory computer-readable storage medium according to claim 19, wherein the processor is further configured to, prior to performing a correlation calculation between the registration embedding vector and each of the sub-audio feature vectors respectively:
in a case that a feature dimension of the registration embedding vector is inconsistent with that of the sub-audio feature vector, map the registration embedding vector and each of the sub-audio feature vectors to a same feature dimension.
